(19) United States
(12) Patent Application Publication
(10) Pub. No.: US 2008/0235237 A1
(43) Pub. Date: Sep. 25, 2008

(54) Computerized Scenario Development And Execution System

(76) Inventor: Talmadge Williams, Kensington, MD (US)

Correspondence Address: WOOD AND EISENBERG, PLLC, 6911 RICHMOND HIGHWAY, SUITE 403, Alexandria, VA, 22306, US

(21) Appl. No.: 11/689,410

(22) Filed: Mar. 21, 2007

(51) Int. Cl. G06F 17/30

(52) U.S. Cl. 707/10

(57) ABSTRACT

A computer based scenario development and execution system permitting a plurality of players (co-located or geographically dispersed) to execute any number of different scenarios that have been defined to the system and are available for execution. During normal use the Scenario Engine (SE) will be running, a user will log-on to said system, complete an authentication procedure, select a scenario for execution, and receive a response indicating that there is a scenario available requiring an additional user, or a new copy of the requested scenario will be loaded and made available for execution. A scenario is made available for execution by retrieving the Scenario Description Language (SDL) for the scenario from the system's library of scenarios, and processing the SDL to provide an executable version of the scenario.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF INVENTION

This invention relates to a system for generating: (1) computerized versions of existing and new games or scenarios; and (2) playing the generated scenarios online in the same or geographically dispersed locations through the use of the Internet or other wide-area communications networks.

### BACKGROUND OF THE INVENTION

Currently there is a growing interest in the development of computerized versions of existing and new scenarios which can be utilized by one or more users (or “players”) co-located, or at geographically separate, personal computing devices. The conventional methods of programming scenarios or games as just another software application program results in all of the traditional time delays necessitated by design, coding, testing, debugging, and distribution of the finished product. Advances in the computer programming field (i.e., structured and object-oriented programming) and distribution (via the Internet and downloading) have tended to reduce these delays. However, one of the disadvantages of the current system are delays in getting newly developed scenarios introduced and available for play online. In addition to fast new scenario turnaround or availability, there is a continuous user demand for new scenarios and modifications to existing scenarios as the user becomes more familiar with the original scenario and its responses, challenges and weaknesses.

U.S. Pat. No. 6,944,655 B1, issued to Bellamy et al, describes a user-defined online interaction device. The device enables a user-defined, genre-structured interaction online. The device enables users to define their own genres, including rules of interaction, as well as rules of enforcement. Genre definitions also can include the specification of roles, parameters, and states. The device also facilitates a given user to modify a given genre definition. Allowable modifications include addition, modification, and deletion of parameters and interaction and enforcement rules. The device provides dynamically updated graphical representations of the state of the various defined genre, these graphical representations are definable by the users.

U.S. Patent Publication Number 2006/0084503 A1, issued to Bian et al. describes a system of automatically generating personalized games and the method thereof. Using a server/user structure, a game controller connects a user to a database server. The server includes a game database for storing game data and a game controller for implementing logic controls. The user has a user engine for implementing a user interface that provides a visualized interface and communicates with the game controller. Thus, characters and scenes can be created according to the user's settings, rendering a personalized game.

U.S. Patent Application Publication Number 2003/0144058 A1 issued to Park describes a game method for allowing the simultaneous playing of a game of “paduck”, chess, Korean chess, etc. through the online Internet in a one-to-many manner. The game method includes the steps of connecting the members with the web site via the internet network, inspecting the member information including their match records and a list of matches, in which the members can participate, provided by the web site, selecting a match from the list of matches, in which the members want to participate, and connecting them with a pertinent match server. When the selected match starts the match server provides the members and the professional with the match screen; when the members select and input moves, the program portion extracts a highest-ranking move, which is the move the majority of the members select. The match server applies the highest-ranking move to the match screens of the members and the professional; when the professional selects a move the match server applies the move selected by the professional to the match screens of all the members and the professional.

### SUMMARY OF THE INVENTION

A computer-based, scenario execution system. The system is capable of accepting descriptions of scenarios in a special-purpose Scenario Description Language (SDL), interpreting and processing those descriptions (SDLs), producing executable versions of the described scenarios by generating executable Objects from the SDL, and providing an execution environment or Scenario Engine to, accept player input, execute the corresponding Objects and display the results to the players. Players may be co-located, sharing the same computer or inter-connected via a local or wide area network (e.g., the Internet) allowing players, separated geographically, to utilize (“play”) the scenario.

This invention includes three major components: (1) a Scenario Description Language (SDL) for describing any single or multi-user scenario (i.e., a playing surface or “theater”, one or more users, players, playing pieces/tokens, a set of rules of play, and a scoring or evaluation method to eventually determine the winning player; (2) a software program, known in the art as an Interpreter which will read the SDL for any game from the library of available games (i.e., collection of SDLs) and create the necessary Objects and Classes in memory or stored temporarily on disk, to enable the execution of that scenario exactly as described in the SDL; and (3) a Scenario Engine (SE) in which users can log-on, select a scenario from the library of available scenarios, determine if one or more instances of the scenario is currently executing (i.e., in play) and if so, request to join an existing session, or if not executing, to request that a new instance of the scenario be initiated and made available for play as an existing session and thus, available for access by other interested users. A new instance of a scenario will comprise of loading into memory for execution, all or some, of the Objects necessary to initiate execution as well as infrastructure routines to request, accept, validate and execute user input (i.e., “moves”.) The SE is also responsible for score-keeping, user authorization and log-on, log-off, and recording individual user historical and statistical data (scenarios played, opponents, and scores), as well as, scenario historical data (e.g., times played, highest score w/user ID, and average score).

### BRIEF DESCRIPTION OF THE DRAWINGS

FIGS. 1A and 1B are a flowchart of the overall processing flow of the Computerized scenario System.

FIGS. 2A, 2B, 2C and 2D are an example of the use of the SDL to generate the well-known game of “Checkers”.

FIG. 3 is a flowchart showing the series of steps and the role of each major component involved in the generation and execution of a scenario.

FIG. 4 is a flowchart showing the relationship between the User Input, selection of a scenario, and selection or identification of the User's opponents for this session.

Similar reference characters denote corresponding features consistently throughout the attached drawings.

### DETAILED DESCRIPTION OF THE PREFERRED EMBODIMENTS

The present invention is directed to a computerized scenario development and execution system. More specifically, the invention is broken into three (3) distinct functional components. The first component is the Scenario Descriptor Language (SDL), the second component is the Scenario Descriptor Language Interpreter (SDLI), and the third component is the Scenario Engine (SE). All the components are described in further detail below.

The term “scenario” is used throughout this application to include the entire range of implementations from traditional board games such as the Checkers example, through and including sophisticated gaming used in military exercises, business competitive analysis, and financial projection and planning.

The Scenario Descriptor Language (SDL) for the chosen scenario contains the definition and description of the various components or “building blocks” of the scenario. The SDL contains all of the data required to describe the scenario, including the graphics and the Object descriptions. It will also contain all the data on interaction between game Objects, avatars, and Districts. See below for definitions of “Connectors”, “Districts”, “Elements”, and “Theatre of Operation”. This includes the conditions for ending the scenario, the rules of engagement, and a listing of all pieces associated with the scenario. The SDL describes the interaction between pieces (both Districts and Elements) and the graphics associated with the Theater of Operation, each District, and each Element.

The Scenario Description Language Interpreter (SDLI) converts the language statements of the SDL for the selected scenario into a set of executable Objects (i.e., blocks of code and associated data) that are loaded into memory by the Scenario Engine in order to execute the scenario.

The Scenario Engine (SE) provides the infrastructure on which the game execution will occur. The Scenario Engine has the following main capabilities: it is self-executing, manages the Graphical User Interface (GUI), manages the scenario's audio output, manages the loading and saving of in-progress scenarios (the Objects produced by the SDLI comprising the scenario), controls all external communications with other computers involved in executing the scenario, and processing user input via mouse and keyboard.

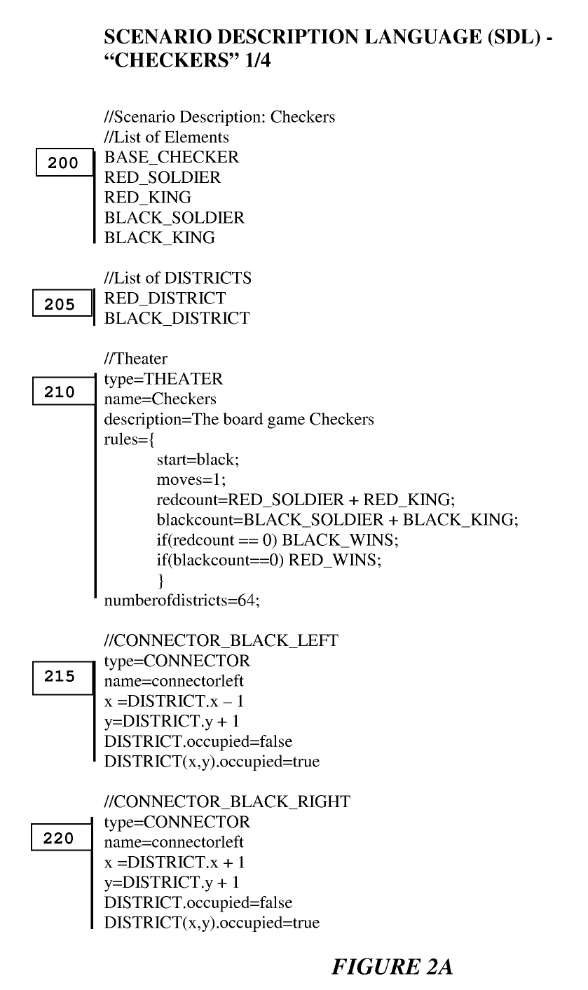

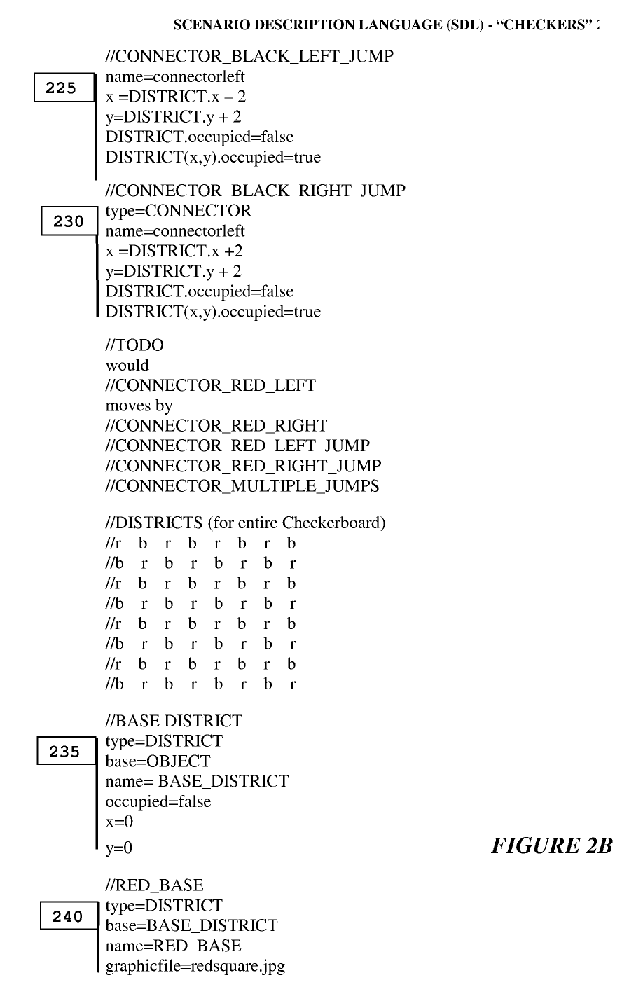

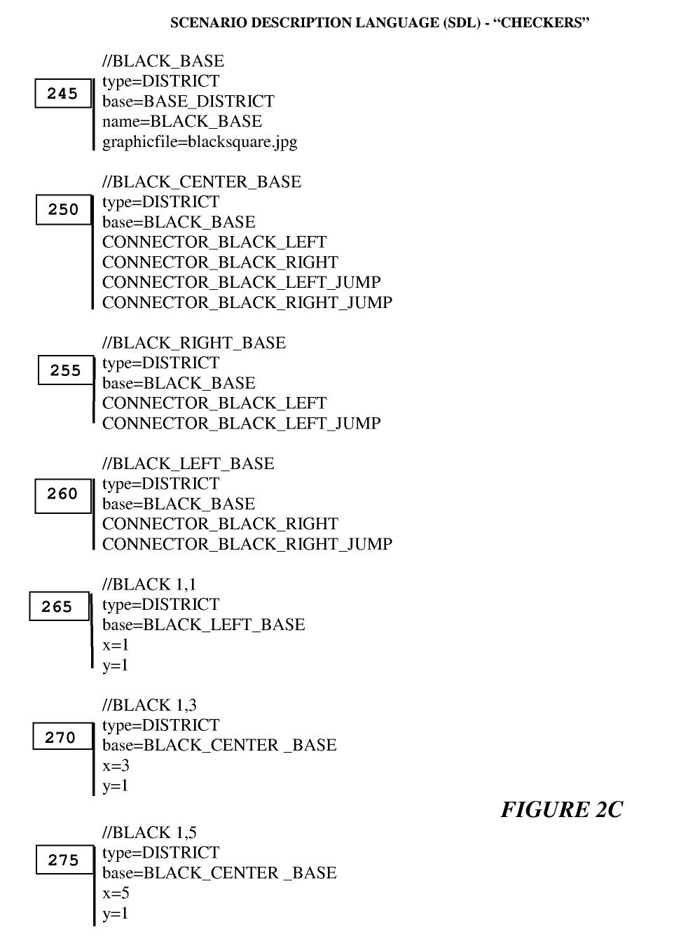

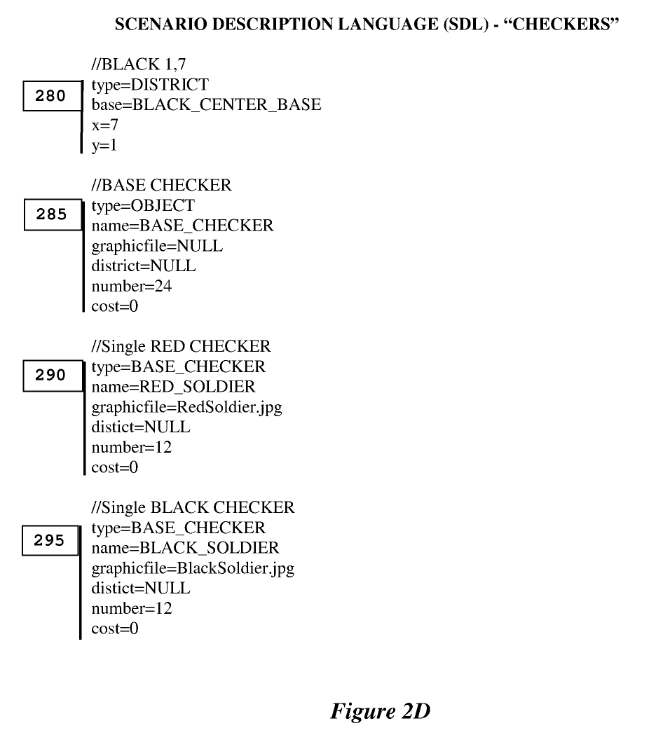

The SE in providing for the scenario execution, must also perform the following tasks with regard to the SDL: loading the correct SDL for processing, reading the SDL data records (see FIG. 2A-2D), checking for SDL file validity (i.e., valid format, valid syntax, valid Object references, and valid Class references), and, whenever necessary, converting the data into executable code using the SDLI by creating any needed Classes or individual Objects.

In addition to processing the SDL via the SDLI, the SE is responsible for actual scenario execution which comprises of the following: loading the scenario (in executable form) into memory, loading all the required Classes and Objects, loading all the required audio or sound files, and loading the required graphic files. When control is passed to the first player for the SE to accept input, the SE will transfer control to the appropriate Object(s) and display the completed request or an error message to the users. Execution will then continue as users enter alternating inputs. Another one of the components of scenario execution is an algorithm for determining whether one or more users have met the “winning conditions” as established for that scenario, and therefore being declared the winner(s), thus concluding the scenario.

The Scenario Description Language (SDL), (sample for the well-known board game of “Checkers” is shown in FIG. 2A-2D below) is a high level programming language that describes a complete scenario. The purpose of an SDL file is to contain the complete functional description of the mechanics of a given scenario. The SDL does not contain any information regarding the mechanics of managing the computer or network environment; this is done by the SE.

The game description written in the SDL will include: the Theater (scenario execution domain), Districts (designated Theater subsets), Elements (various tokens or “game pieces”), and the permitted interactions or Connectors between the Districts, Elements and the Theater. For a given game or scenario described in the SDL, there will be only one Theater, which will contain the rules of the game. There may be multiple Districts (i.e., game spaces, squares or subsets of the Theater) and Elements (i.e., tokens or pieces). Each District and Element will be a self contained “Object”, meaning that it has all the data required, including its attributes and its interactions with other Elements or Districts. The SDL must be able to describe all interactions within, and between, all Objects for any given scenario or situation. This complete description of the scenario will allow for new functionality (e.g., changes to rules of engagement, scoring, and allowed executions) to be created automatically by the engine when it reads a new or modified file, containing the changes, written in the SDL.

The SDL utilizes an object-oriented design approach. The Objects comprise the following: THEATER (Theater of operations, e.g., the scenario playing field) including a description of the scenario; the rules of engagement or play; number of DISTRICTS; and, the crucially important-winning conditions.

DISTRICTS comprise of: an area of execution (e.g., a single square on a Checker board); ELEMENT modifiers associated with that DISTRICT (e.g., changes to the properties of a Checker if it reaches certain squares, e.g., “King-ing”); and CONNECTORS to other DISTRICTs (i.e., allowed “moves”).

CONNECTORS comprise of: values associated with the cost to move from one DISTRICT to another; and, restrictions on the allowed move(s) from one DISTRICT to another.

ELEMENTS comprises: playing pieces (e.g. in a board game), where each piece has programmer-defined attributes (e.g. allowed attack moves, defense moves, and other permitted movements)]; allowed interactions with other ELEMENTS (e.g. in checkers “Jumping”); and, allowed interactions with DISTRICTS (e.g. permitted or allowed next move(s), given current location and/or status).

The contents of an SDL file (see FIGS. 2A-2D for a sample SDL file for Checkers) will include the following data structures, or “statements” in the SDL: THEATRE (including descriptive data identifying the scenario, and the primary rules of play including the “winning condition”); list of all ELEMENTS types (delimited by colon); list of all CONNECTORS (delimited by colon); and, list of all DISTRICTS (delimited by colon).

The THEATRE statement contains: Name; Description; Rules of engagement; (e.g. Black starts first; No using white districts); Winning condition (e.g. No Red Checkers=Black win, No Black Checkers=Red win); the total number of DISTRICTS composing the game; and, a Board graphic file, “checkers/board.jpg” for displaying the universe of play and current positions to the users.

The DISTRICTS statement contains: District Type; District Name; Base DISTRICT; CONNECTORS (defined by Type, Unique ID, Destination DISTRICT, COST, and Restrictions); ELEMENT modifiers (movement penalties for specific ELEMENT types, and possibly, a District graphic file).

The ELEMENTS statement contains: Element Type; Element Name; Base ELEMENT; Attribute1 . . . AttributeN (for each Element: movement points, attack points, and special attacks); Element interaction with DISTRICTS; ELEMENT interaction with other ELEMENTS; any other possible interactions; and, an ELEMENT graphic file (e.g., RedChecker.jpq)

The SDL file will, in effect, describe the mechanics of the chosen board game to the SE. It will also include the necessary file references for all graphics used to interface with the player (the Graphical User Interface or GUI), but will not include the actual graphics file. When used in conjunction with the SE, the SE is responsible for handling all interactions with the specific computer environment (e.g., Microsoft Windows) required to execute the game and maintain the GUI and keyboard interface with the user(s). This handling of the execution environment includes managing all basic interactions associated with the scenario disk IO, keyboard I/O, mouse clicks, display graphics, and audio.)

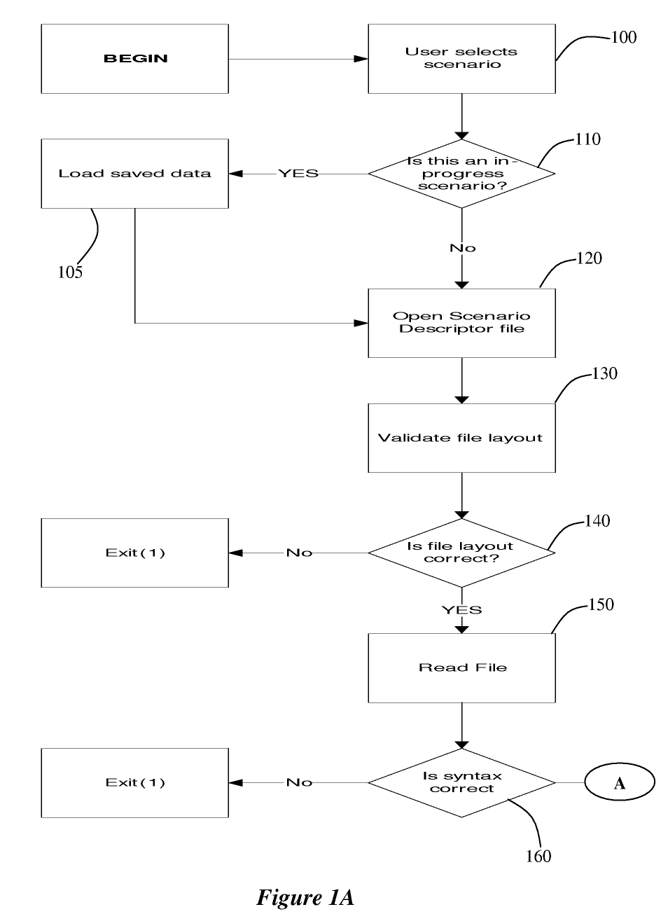

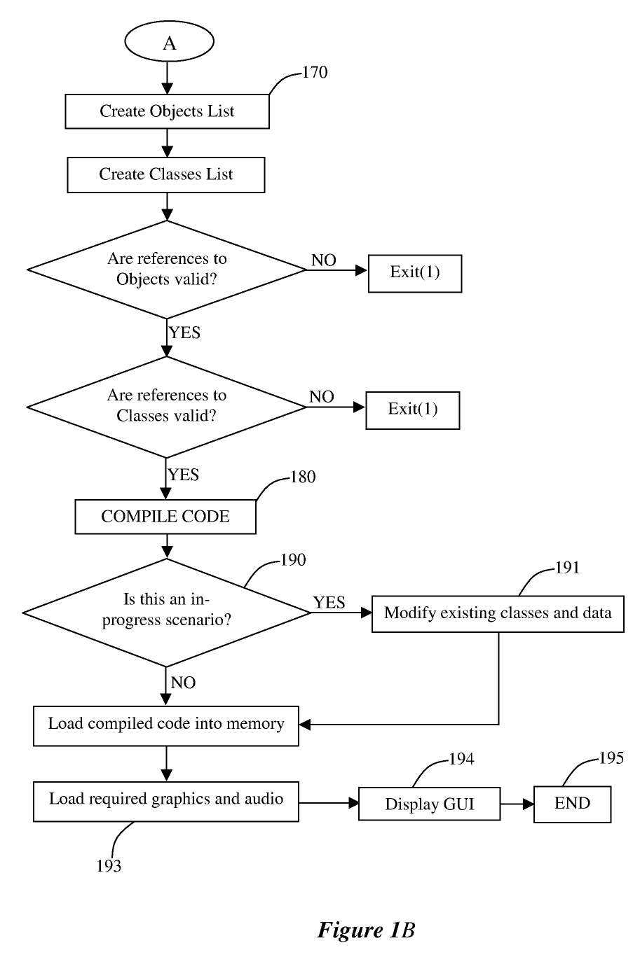

FIGS. 1A and 1B describe the steps used in going from the User's selection of a scenario at 100 through the completion of the retrieval, validation, compilation, and transfer of control to the SE for execution following termination at 195. If the selected scenario is already loaded and in progress at 110, the system can load saved data at 105 or locate and open the appropriate file containing the needed SDL at 120. Once the file is validated (this validation is simply of the file layout or structure to determine that it is really an SDL file) at 130, if the layout is correct at 140 the file is read at 150 and the syntax checked at 160. If the syntax is correct the Objects can be created from the SDL at 170 (see FIG. 1B), this results in compilation of code and hence Object creation at 180 and will either be loaded and started as a new scenario (i.e. no currently running copies loaded) or used to modify classes and data in an in-progress scenario at 191. The graphics and audio files are loaded at 193, the Graphical user Interface at 194 will display the starting scenario image, and transfer control to the SE for actual scenario execution following termination at 195.

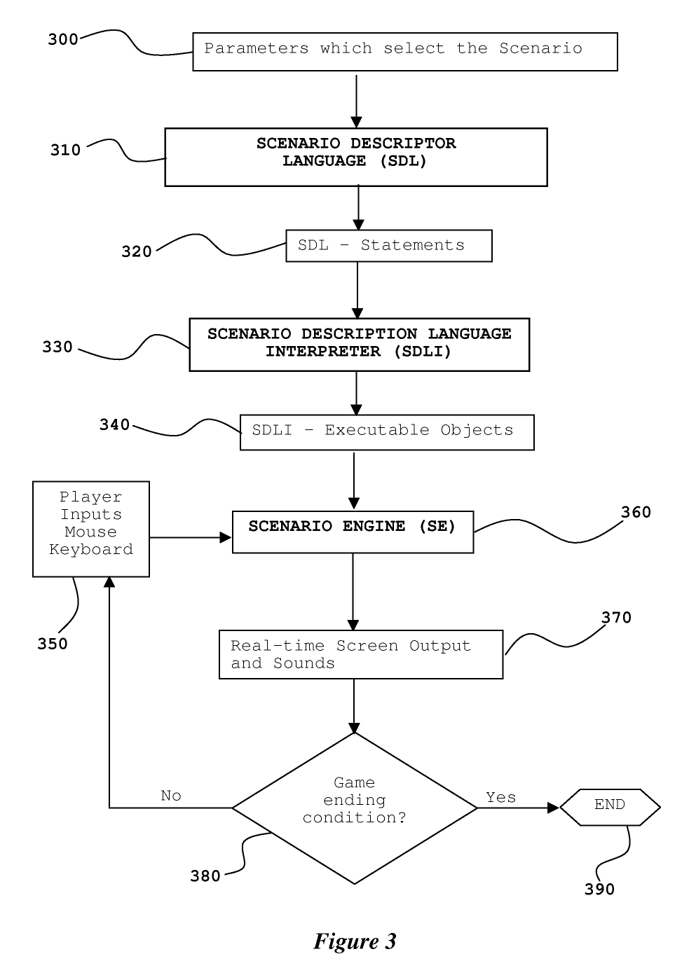

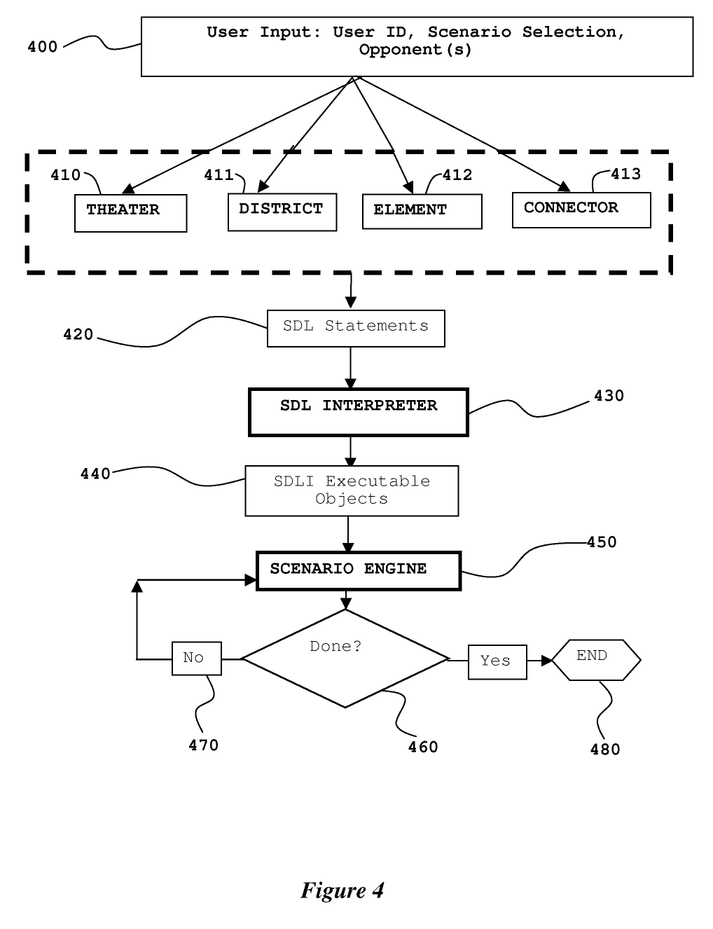

The following figures provide additional detail on the functionality of the system: FIGS. 2A through 2D are a sample of the SDL for the conventional game of Checkers; FIG. 3 shows the use of the SDL and SDL Interpreter to convert the scenario description into executable Objects that are then executed by the SE along with the necessary housekeeping software (GUI, scorekeeping, and termination); and FIG. 4 which expands to show some detail on the component Object-types of the SDL.

FIGS. 2A through 2D illustrate how Scenario Description Language (SDL) can be used to describe a game of Checkers. It will be understood that the Scenario Description Language (SDL) is not limited to the game of Checkers, but can be applied to describe, for example, any board game including known board games and new board games. This example demonstrates the use of the basic types of Statements (THEATER, DISTRICT, ELEMENT, and CONNECTOR) to describe the enablement of the scenario in the SDL. Beginning on FIG. 2A, the list of Elements shown at 200 lists at the possible ELEMENTS contained in the scenario. Each of the ELEMENTS represents a Class of Objects that will be defined by later statements and which will be converted into Objects executable under the control of the SE. Similarly, the list of DISTRICTs shown at 205 represents the possible types of DISTRICTs which can exist in the scenario. The THEATER statement at 210 describes the environment of a scenario and the definition of the rules of “play”, as well as conditions for a “win”. The CONNECTOR statements at 215 (FIG. 2A) through 230 (FIG. 2B) define the possible moves within the scenario, where “x” and “y” are the horizontal and vertical coordinates, respectively, on the playing theater; and, the attribute “occupied” is true when the designated DISTRICT (e.g. square on the checkerboard) is vacant, or false when occupied (e.g. by a checker).

The SDL utilizes the inheritance concept of object-oriented programming to build upon earlier DISTRICT Objects to create the full set of Objects necessary to completely define the playing theater. This is best demonstrated by the definition of the BASE DISTRICT at 235 (FIG. 2B) which defines the minimal attributes of a DISTRICT Object (x & y coordinates of the location of the square on the board, and the occupied (true or false) attribute.) Building on the definition of the BASE DISTRICT Object at 235 is the RED BASE shown at 240 (FIG. 2B) and the BLACK BASE at 245 (FIG. 2C) Objects are built on the BASE DISTRICT by adding either a “redsquare.jpg” or “blacksquare.jpg” graphic, respectively, to the RED BASE at 240 and BLACK BASE at 245 (FIG. 2C) to provide Object definitions. Further building on the inheritance concept, SDL utilizes the BLACK BASE Object at 245 containing the BASE DISTRICT Object at 235 and adds the possible next moves by combining a CONNECTOR Object with a DISTRICT Object to create a new DISTRICT Object. This is best seen in the BLACK CENTER BASE Object 250, the BLACK RIGHT BASE Object shown at 255, and the BLACK LEFT BASE Object at 260, all of which are made up of the appropriate combination of the BLACK BASE at 245 and the appropriate CONNECTORs at 250 through at 260.

The need for CENTER, LEFT and RIGHT implementations of the DISTRICT Object is a characteristic of many board-type games. Since the THEATER defines the boundaries of the playing area, special conditions apply at the boundaries, thus at the left edge of the checkerboard a checker can only move right so BLACK LEFT BASE at 260 only contains the CONNECTORs for a single move right (CONNECTOR BLACK RIGHT shown at 220) and the possibility of a jump to the right (CONNECTOR BLACK RIGHT JUMP at 230) thus preventing an illegal attempt to jump left off the board. Based on the above components, the SDL can generate the 24 black squares (See FIG. 2C and 2D, 265-280), which are a subset of the total set of square objects, and 24 red squares, which comprise the actual playing surface or board. The right edge DISTRICTs are similarly programmed to preclude impossible and illegal moves. Once a checker ELEMENT is away from the edges, (e.g. in the CENTER) all moves (CONNECTORs) are included and thus allowed for those Objects.

The final set of required Objects are the ELEMENTs describing the playing pieces, or checkers in the present example. Again looking at FIG. 2D, utilizing the concept of inheritance a BASE CHECKER at 285 is defined, and then RED CHECKER at 290, which has programmer-defined attributes of a red checker (e.g. graphicfile=RedSoldier.jpg, number of pieces=12) and BLACK CHECKER at 295, which has the attributes of a black checker (graphicfile=BlackSoldier.jpg, number of pieces=12).

FIG. 3 shows the series of steps and the role of each major component involved in the generation and execution of a scenario. The user will logon and select an available scenario for play at 300 from a library of database of scenarios. This will cause the SE to locate the appropriate set of SDL shown at 310 for the selected scenario, and present the statements at 320 (in SDL) for the selected scenario to the Scenario Description Language Interpreter (SDLI) at 330. The SDLI processes each SDL statement at 320 to produce the executable Objects at 340 that will be used by the SE, which in FIG. 3 is shown at 360, to provide a playable scenario to the User. The SE 360 will then initialize the scenario by executing the Objects needed to establish the Theater for play.

The execution or “playing” of the scenario comprises of the SE at 360 operating in a loop that comprises: the SE shown at 360 outputting or displaying the current status of the Theater at 370 to the User(s). The SE at 360 is continuously updated until a predetermined game ending condition occurs at 380 (see FIG. 3), e.g., such as a winner. Absent a winner the SE at 360 will accept additional inputs from the Users at 350 and play will continue; if the rule for determining a winner, determines that a User has satisfied the rule (i.e., “won”) the scenario will end at 390.

FIG. 4 shows the relationship between the User Input at 400 which identifies the User to the system, allows selection of a scenario (existing scenario already loaded and ready for play or loading and startup of a new scenario) and selection and identification of the User's opponents for this execution of the scenario. The scenario selection causes a specific file of SDL to be retrieved containing THEATER shown at 410, DISTRICT at 411, ELEMENT at 412, and CONNECTOR shown at 413, which collectively generate descriptions or statements at 420 which are then presented to the SDL Interpreter (SDLI) shown at 430. The SDLI creates the SDLI executable Objects at 440 which are then executed by the SE, which in FIG. 4 is shown at 450, to play the game as described above for FIG. 3 (350, 360, 370, 380 & 390.)

It is to be understood that the present invention is not limited to the embodiment described above, particularly the Checkers example, but encompasses any and all embodiments within the scope of the following claims.

I claim:

1. A method of providing a computer-based scenario development and execution system, comprising:
providing a log-on screen on a remote computer console, said log-on screen providing connectivity between a prospective player and a scenario execution server, said server at least partially under the control of a Scenario Engine algorithm;
performing a user verification step for each prospective user requesting to log-on to said server;
allowing each authorized player to select a desired scenario;
providing a scenario previously created using a Scenario Development Language(SDL), said SDL being a high-level programming language that describes a scenario, said SDL comprising:
a THEATER Object;
a DISTRICT Class;
a ELEMENT Class; and
a CONNECTOR Class;
executing each selected scenario using a Scenario Development Language Interpreter (SDLI) in combination with said Scenario Engine algorithm to process user inputs until a conclusion is reached; and
recording a set of scenario statistics upon conclusion of each scenario.

2. The computer-based scenario development and execution system, wherein said components: Scenario Description Language, Scenario Description Language Interpreter and Scenario Engine algorithm, are stored and executed within a single personal computer shared by all of the scenario users.

3. The computer-based scenario development and execution system of claim 1 or claim 2, wherein said Scenario Engine algorithm maintains a database, said database contains a record of authorized users, and users' statistics.

4. The computer-based scenario development and execution system of claim 1 or claim 2, wherein said Scenario Engine algorithm maintains a database, said database contains a record of authorized users, and users' statistics, wherein said user statistics includes for each user details on every scenario executed including: scenario title and version, date executed, names of opponent users, scenario result, total number of wins, and total number of losses.

5. The computer-based scenario development and execution system of claim 1 or claim 2, wherein said Scenario Engine algorithm maintains a real-time record of all users and scenarios currently in execution, including, but not limited to, the user identity and the scenario being requested or currently in execution.

6. The computer-based scenario development and execution system of claim 1 or claim 2, wherein for each scenario currently in-execution said Scenario Engine algorithm matches users waiting to execute a selected scenario.

7. A computer-based system for developing and executing an active scenario, comprising:
a Scenario Descriptor Language(SDL);
a Scenario Descriptor Language Interpreter (SDLI); and
a Scenario Engine algorithm (SE);
wherein said interpreter (SDLI) receives as inputs statements in said scenario language (SDL) to generate commands and messages for execution by said SE to provide the active scenario on the user's computer;
said SDL being a high-level programming language that is utilized to describe a given scenario, comprising:
a THEATER Object;
a DISTRICT Class;
a CONNECTOR Class; and
an ELEMENT Class,
wherein said THEATER Object is responsive to inputs that define:
the layout of the scenario theater or execution environment,
the rules of the scenario execution, and
the conditions defining a win;
wherein said DISTRICT Class comprises Objects which are responsive to inputs that define:
an area of execution within said THEATER, and
the set of said CONNECTOR Objects or moves permitted between said DISTRICTs;
wherein said ELEMENT Class comprises Objects which are responsive to inputs that define:
tokens included in the scenario, the permitted moves associated with each of said tokens, permitted interactions between said tokens, and
permitted interactions with the said DISTRICT(s);
wherein said CONNECTOR Class comprises Objects which are responsive to inputs that define:
at least one permitted move between DISTRICTs;
said SDLI being an interpreter of SDL;
wherein said SDLI is responsive to inputs comprising of statements in said SDL that when processed by said SDLI will result in:
graphical display output by said SE of the scenario theater on each user's computer display, and
graphical display output by said SE of the current active scenario tokens and moves on each user's computer display;
said SE being an execution engine;
wherein said SE is responsive to commands and
messages from the SDLI which will result in:
accepting as input each user's move, updating the graphical display of each user's move(s) on the display of the scenario theater,
computing and maintaining each user's current score,
terminating the scenario upon determination of a win or tie.

8. The computer-based system of claim 7, wherein the SDL is capable of describing existing, modified existing, and newly developed, versions of scenarios.

9. The computer-based system of claim 7, wherein the SDL descriptions of all the scenarios available for execution on that server or stand-alone personal computer (if not networked) is stored in a database or library.
